(19) United States
(12) Patent Application Publication
(10) Pub. No.: US 2024/0084895 A1
(43) Pub. Date: Mar. 14, 2024

(54) Self-Sealing Mounting and Fastening Element

(71) Applicant: Reidar HAGNER, Sundsvall (SE)

(72) Inventor: Reidar HAGNER, Sundsvall (SE)

(21) Appl. No.: 18/461,996

(22) Filed: Sep. 6, 2023

Related U.S. Application Data
(60) Provisional application No. 63/405,540, filed on Sep. 12, 2022.

(51) Int. Cl. F16J 15/02; F16B 15/00

(52) U.S. Cl. CPC F16J 15/022; F16B 15/00

(57) ABSTRACT

A sealing fastening member has a main body that in turn has a central bore for receiving a fastener, a bottom contact surface, and a protruding portion protruding from the bottom contact surface. Initially, the fastener extends through the central bore and at least partially into an underlying surface; the protruding portion is in contact with the underlying surface. The bottom contact surface is thereby being at a distance from the underlying surface. The protruding portion then at least partially liquifies under the force of an installation action carried out on the fastener and seals around a point of penetration of the underlying surface by the fastener. During a second phase, the bottom contact surface is in contact with the underlying surface and the fastener is secured in the underlying surface.

### CROSS-REFERENCE TO RELATED APPLICATIONS

This application claims priority of U.S. Provisional Patent Application No. 63/405,540, filed 12 Sep. 2022.

### FIELD OF THE INVENTION

This invention relates to fasteners.

### BACKGROUND

Elements such as screws and nails are often used to fasten one thing to another. When it comes to screws, nails, and the like, at least two surfaces are typically penetrated, that is, surfaces of the two objects to be fastened. In applications in which the surfaces are exposed to moisture, the moisture may penetrate into the underlying surface via the hole(s) made by the fastener; sealing depends on how fully and how tightly the fastener “fills” the hole(s). One weakness of this solution is that this seal, such as it is, may weaken over time because the hole in the upper surface gets bigger due to flexing or other motion of the underlying surface relative to the upper surface.

One common way to alleviate the problem of leakage is to include a layer of waterproof underlayment between the two surfaces. In constructing a roof, for example, a layer of tar paper, asphalt-saturated felt, or a sheet of a similar synthetic material, is laid on top of the underlying roof sheathing; the roof covering, such as metal, tiles, etc., is then laid on the underlayment. The fasteners then are screwed or driven through the covering, the underlayment, and into the sheathing. The idea of this common solution is that the waterproof substance (tar, asphalt, etc.) in or comprising the underlayment will adhere to the surface of the fastener well enough to better prevent leakage, even when the surfaces flew and move, at least some.

Another solution, which is often used together with an underlayment, is to provide the fastener with some additional waterproof member such as a gasket. Gasketed screws are almost universally preferred for securing metal roofs, for example. One weakness of conventional gasketed screws is that the gaskets dry out over time, crack, and leak. Another shortcoming is that the ability of the gasketed fastener to seal properly depends heavily on proper installation. The gasket will not properly seal if, for example, the screw is over- or under-tightened.

### BRIEF DESCRIPTION OF THE DRAWINGS

FIG. 1 is a perspective view from below of one embodiment of a spacer.

FIG. 2 is a view of the spacer from above.

FIG. 3 is a side view of the spacer.

FIG. 4 is a bottom view of one embodiment of the spacer.

FIG. 5 is a cross-sectional view of the spacer.

FIGS. 6A-6D illustrates the spacer together with a fastening element and the way in which the spacer in illustrated embodiment deforms during installation on a base material.

### DESCRIPTION OF EMBODIMENTS

As will become clearer from the description below, the invention provides an arrangement in which a sealing element and a fastening element (“fastener”), together referenced as 1, interact with a surface so as to seal a point of entry. The arrangement may be used to mount one object at a distance from another, or to join two objects to each other. Because it is anticipated that the most common application of the invention will be in the context of connecting two items with each other, with spacing, the invention is described below primarily in this context, such that the sealing element 100 is referred to as a “spacer”. Moreover, the protruding portion and groove (described below) are both shown as being annular and the protruding portion is in sometimes referred to as a “collar” or “collar portion”; this too is by way of non-limiting example, chosen because it was this configuration that the inventor first tested.

The shape of the spacer and the type of fastening element used may vary depending on how the arrangement is intended to be used. Different options are explained below but in general one should keep in mind that the illustrated embodiment is just that, namely, an illustration of one embodiment and that the general configuration of the illustrated embodiment may be applied to spacers having different shapes and different types of fasteners as well.

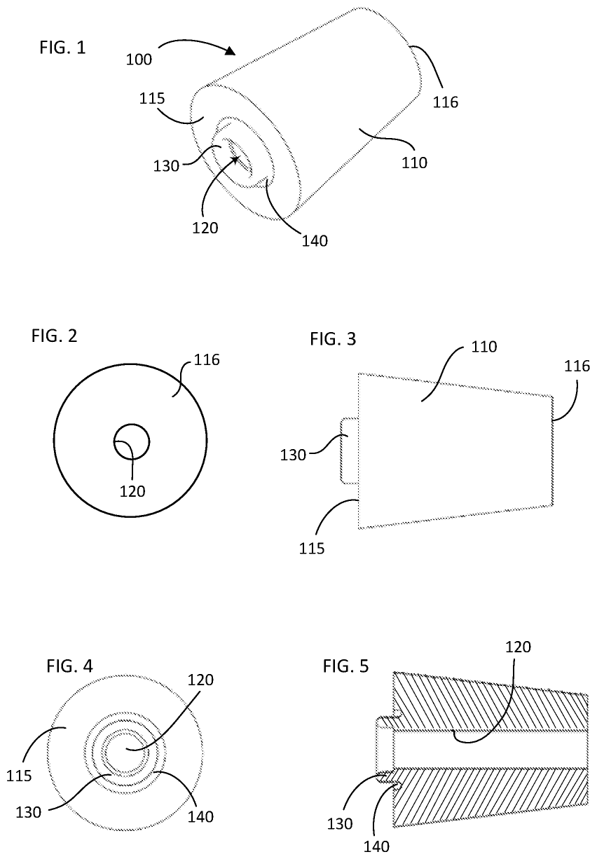

FIG. 1 is a perspective view of one embodiment of the spacer 100 viewed mostly from below. The spacer includes a main body 110, which has a bottom contact surface 115 and a top surface 116. In the illustrated embodiment, the main body 110 generally has the shape of a frustum of a cone but, again depending on the implementation, it could have some other shape such as a cylinder, a hemisphere, etc. One advantage of the generally conical shape is that it will perform as needed (see below) with minimal wastage of the material from which it is made.

A central bore 120 extends along the axis of the main body 110. A protruding portion 130 extends from the bottom surface 115 and an optional groove 140 is formed in the bottom surface 115. In the illustrated example, both the protruding portion 130 and the groove 140 are annular, with the groove 140 located radially outward relative to the protruding portion and both surrounding the central bore. Examples of alternatives to this configuration are described below.

FIGS. 2-5 depict the spacer 100 from the top, side, bottom, and in cross-sectional view, respectively.

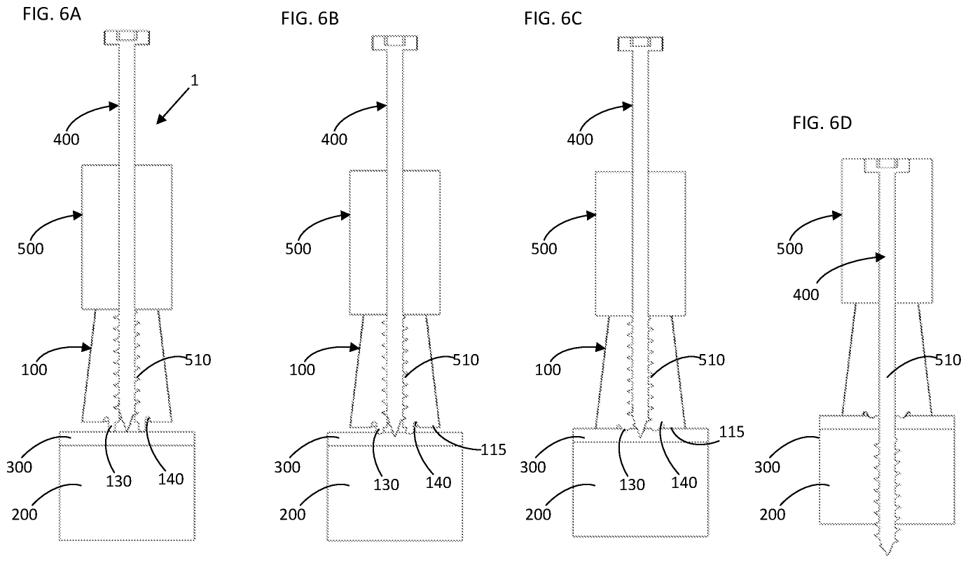

Now see FIG. 6A, and assume that the arrangement is to be used to mount a first item 500 onto a second item 200. First, note that FIGS. 6A-6D should be viewed as cross-sectional; hatching indicating this has been omitted for the sake of clarity. Here, the assembly of the fastener 400 and the spacer 100 is shown with the common reference 1. It is not necessary for this assembly to be manufactured and delivered as a unit, although this is an option; rather it would be possible to provide the spacer separately, with the user choosing or being provided a fastener according to manufacturer specifications to achieve the sealing effect described below.

In the illustrations, the spacer is between the two items 200, 500. In some applications, however, the items are intended to be fastened to each other directly, that is, with item 500 lying directly on item 200 (with or without one or more intermediate layers), in which case spacing is not required. The principle feature of the invention—“automatic” or “self” sealing—(described below) may be applied even in this case, with the thickness (height as viewed in FIG. 6A) of the sealing element 100 reduced; the invention in such cases may then be used to replace and improve on such existing fasteners such as gasketed screws.

In some situations in which the invention may be used, a covering 300 is located on top of the item 200, that is, between the item 200 and the assembly 1.

In the illustrated embodiment, the fastener is a threaded wood screw, but this is simply a design choice that will be made depending on how the assembly 1 will be used. As is explained further below, the fastener 400 could be some other type of screw or even a non-threaded element such as a nail.

One prototype of the invention was made and tested in the context of installing battens on a roof. In particular, the context of the prototype was as is described in International Patent Application PCT/IB2021/055504 (“Batten Arrangement for Building Surfaces”), namely, as a replacement for the spacing element described in that application, in which bands that extend perpendicular to a set of battens are used to maintain the relative distance between the battens when deployed on a roof. This is of course only one use and the present invention may be used in many other contexts as well. In the context of installing battens on a roof, however, the first item 500 would be the batten and the second item 200 would be the roof sheathing such as wood panels. The covering 300 would then typically be any conventional underlayment product such as “tarpaper”, which, in modern constructions is usually a sheet of material covered in asphalt (also known as bitumen). In such a use case, the assembly 1 may be used to secure the battens in place on the roof.

Now see FIG. 6B and consider what happens when the user begins to install the screw, of course using any conventional tool (not shown) suited to the purpose and the type of screw used. The user will generally first press down on the fastener 400, which will cause the tip of the fastener to begin to penetrate the covering 300, or the upper surface of the base item 200 if it does not have a covering. Initially, only the protruding portion 130 of the spacer 100 will then be in contact with the surface of the covering 300, and will begin to compress.

The collar portion 130 is preferably dimensioned so as to have a thickness (measured in the radial direction) great enough not to “collapse” under this initial downward (viewed as in FIG. 6B) pressure. The dimensions of the collar portion 130 will therefore vary depending on the use to which the assembly 1 is to be put and can be determined as needed using known design and experimental methods.

During this initial phase, the bottom surface 115 will not yet be in contact with the surface of the covering 300, or at most will have only minimal contact, for example, if the user is holding it at a tilt. The protruding portion 130, however, will be in contact with the underlying surface.

While still pressing down, the user will begin to also cause the fastener 400 to rotate, in order to engage the threads 510; in simpler terms, the user will screw the screw into the main body. The inner diameter of the central bore should therefore preferably be less than the diameter of the intended fastener so that the fastener will be able to “grip” the spacer enough to cause this rotation; alternatively, inner threading in the central bore should be configured so as to create enough friction on the fastener threads that the spacer will rotate. Determining the proper dimensions in this respect are within the skill of any mechanical engineer. The protruding portion 130 is configured such that the friction between it and the upper surface of the covering 300 (or item 200) is not be great enough to completely resist the torque applied to the fastener 400, but rather the spacer 100 is able to rotate. One way to arrange this is to configure the protruding portion 130 closely adjacent to the central bore through which the fastener 400 extends, thereby reducing the moment arm of the force of friction. This isn't the only option. In one embodiment, “closely adjacent” is so close that the innermost radial portion of the protruding portion forms a common edge with the central bore. In other implementations, the radial distance from the center of the center bore to the middle of the protruding portion should be less than half, and preferably less than one third, the radial distance to the outer edge of the bottom contact surface 115, A skilled mechanical engineer will be able to use known design methods to determine the proper distance, corresponding to the radius of the protruding portion where this is annular, for each intended use of the invention as a function of the type of fastener to be used, the material from which the protruding portion is made, and the underlayment the invention is to be used on.

As is known, the amount of friction that arises on the protruding portion will be proportional to not only to the downward force applied, but also the area in contact with the underlying surface. The resistance to rotation will then be a function not only of the accumulated frictional force, but also of the radial distance of contact, measured from the axis of rotation (the axis in the middle of the central bore). The thickness and radial location of the protruding portion may be determined using standard methods, also taking into account the properties of the underlying surface the invention is to be used for. In general, however, this means that, at this point, the entire spacer 100 will generally rotate along with the screw.

Depending on the materials comprising the protruding portion 130 and the covering 300 (or surface of the base item 200), significant friction will then arise and cause the protruding portion 130 to at least partially liquify and, in this form, encircle the hole that the fastener will cause in the underlying surface, and thus form a sealing “ring” around where the tip of the fastener has at least initially penetrated the underlying surface. This is illustrated in FIG. 6C. Depending on how much heat is generated, the upper surface of the covering 300 may also at least partially liquefy, although this is not necessary. The protruding portion 130 will in any case therefore tend to “melt” into and seal the covering 300 around the point of entry of the fastener 400. The groove 140, if provided, provides an annular region into which the any excess (more than is needed to seal securely around the bore) amount of the partially liquified protruding portion may expand and flow and thereby avoid creating any kind of “lump” of the spacer 100 and allowing the bottom contact surface to seat substantially flush onto the underlying surface.

Once the assembly 1 has reached the position shown in FIG. 6C, the bottom surface 115 may fully seat on and come in contact with the upper surface of the covering 300; this starts the second installation phase. This will of course greatly increase the amount of friction, such that the spacer 100 will no longer rotate along with the fastener 400, whose threads 510 may then engage the covering 300 and base material 200 and penetrate to the proper installation depth. In the installed position, depicted in FIG. 6D, the point of entry of the fastener will thereby be sealed even when the liquified material has hardened.

As mentioned above, it is not necessary for the fastener 400 to be a threaded screw. As one alternative, it could be a nail such that the initial pressure on the protruding portion 130 when the nail is first driven in causes it to partially liquefy and meld with the surface 300. The spacer 100 may therefore be used not only with fasteners that are installed through rotation, but also those installed using some form of impact or other pressure. In implementations in which the invention is used with a nail, there will be no or minimal rotation during installation. Configuring the protruding portion substantially as an annulus will therefore not be as relevant. Liquification of the protruding portion 130 will instead depend primarily on the pressure generated within the protruding portion when the nail is struck. In both cases, however, it is a force generated by an installation action (pressing and rotating to generate both pressure and friction, or impact force leading to high pressure) that leads to at least partial liquification of the protruding portion. To ensure sufficient impact pressure on the protruding portion, the inner diameter of the central bore should be chosen, using normal design methods, to be sufficiently less than the diameter of the fastener, such as a nail, that is to be driven in.

In some implementations, in particular where the fastener is a screw, the primary fore component causing liquification will in most cases be from rotational friction; in the case of non-rotating fasteners such as a nail, the primary force component, in particular, impact force, will be downward, that is, in the normal direction (perpendicular) from the underlying surface. In some circumstances, both the downward force component (especially impact force) and the rotational friction component may be necessary to cause self-sealing of the fastener through at least partial liquification of the protruding portion 130. For example, assume that the invention is to be used in place of a conventional gasketed screw to install metal roofing on roof sheathing such as wood panels, possibly with an intermediate barrier layer. In this case, the sealing element 100 will be in contact with a surface (metal) that will typically be smoother than, and give rise to less friction than, for example, roofing tar paper or wood. In these cases, the manufacturer of the sealing element may specify for the user a minimum amount of downward installation pressure and a minimum, maximum, or range of RPMs, to cause sufficient liquification. These values may be determined for different substrates (metal, tar/asphalt paper, wood, etc.) using known testing methods and may be supplied along with the sealing elements.

In one prototype, the spacer 100 was molded as a unit using material made from recycled tires. This choice proved to be not only environmentally advantageous (because it uses a recycled material) but also had sufficient firmness for supporting a batten on a roof but also was able to generate enough friction between the protruding portion 130 and roofing paper (asphalt-based) to cause the partial equivocation and sealing described above. The material chosen from which to make the sealing unit 100 may be varied to accommodate the surface properties of an intended substrate. For example, “stickier” materials may be preferable if the substrate (the upper, contact surface of the item 200, or of the layer 300) is to be smoother, such as metal roofing. Common vehicle tires are made of a mixture of many different ingredients, which vary from manufacturer to manufacturer, but will in general have, as main components, one or more synthetic rubber such as Butyl Rubber, Polybutadiene Rubber, Styrene-Butadiene Rubber, and Halogenated Polyisobutylene Rubber, all of which, individually or in any combination, may be suitable materials from which to manufacture the sealing unit. Yet another suitable material is the synthetic rubber known as Ethylene Propylene Diene Monomer (EPDM), which has the advantageous property that it is highly resistant to weathering. A skilled construction or mechanical engineer will readily be able to choose the material depending on the intended or anticipated substrate. Even natural rubber may be a suitable material for use on some substrates, alone or in mixture with other materials, including synthetic rubber.

In the figures, the protruding portion is shown as being of substantially constant thickness (in the radial direction) and rounded. This is just one design choice. The cross section of the protruding portion could be rectangular, or conical, for example, or even triangular, pointed at the point of contact with the underlying surface.

As already mentioned, it is also not necessary for the protruding portion to be annular, although this choice will generally, for reasons of symmetry, be the most natural in situations in which the sealing element 100 rotates. Even where the protruding portion is arranged at a substantially constant radius, it need not be continuous, that is, unbroken, but rather could be comprised of circle sectors. In embodiments in which rotational friction (induced, for example, by a screw) causes liquification, even point or line contact protrusions (such as “dots” or “ribs”) may be “smeared” during rotation into a continuous, sealing band. As long as the central bore is completely surrounded by a continuous band of “melted” material, the bore will be sealed.

The groove 140, if it is included at all, may similarly be configured other than as a continuous annulus, given that its purpose is primarily to provide a place for “overflow” of liquified material to run into so as not to interfere with firm connection between the bottom surface 115 of the sealing element and the upper surface of what underlies it. The groove could comprise disjoint sectors, for example, or could be arranged as a set of radially extending grooves, or a pattern of “dimples”.

In the figures, the central bore 120 is depicted as having a substantially constant diameter. In some embodiments, this may not be the most effective design choice. It would, for example, be possible to form the bore to have a non-constant diameter. As just one example, some screws are tapered over their length, or have a threaded length that is thinner than a smooth shank adjacent to the head. In these cases, it may be advantageous for the bore 120 to have a corresponding shape so as to maximize initial friction-generating torque on the protruding portion 140. In other cases, the screw may have a substantially constant diameter, but it may be advantageous for some region of the bore to be narrower than another. For example, if the material from which the sealing element 100 is made is comparatively more elastic than another material, it may be advantageous from the perspective of initial torque generation to narrow a portion of the bore so that it will better “grab” the screw during the initial liquification phase of installation.

1. A sealing fastening member comprising:
a main body that has
a central bore for receiving a fastener;
a bottom contact surface;
a protruding portion protruding from the bottom contact surface;
whereby,
during an initial liquification phase:
the fastener extends through the central bore and at least partially into an underlying surface;
the protruding portion is in contact with the underlying surface, the bottom contact surface thereby being at a distance from the underlying surface;
the protruding portion is caused to at least partially liquify under the force of an installation action carried out on the fastener and, in an at least partially liquified state, to seal around a point of penetration of the underlying surface by the fastener;
during a second phase:
the bottom contact surface is in contact with the underlying surface; and
the fastener is secured in the underlying surface.

2. The sealing fastening member of claim 1, in which the main body also forms a spacer between a first item and a second item.

3. The sealing fastening member of claim 1, in which the fastener is a threaded screw, whereby the installation action is screwing the screw through the central bore, whereby the force of the installation action has a primary component of rotational frictional between the protruding portion and the underlying surface.

4. The sealing fastening member of claim 1, in which the fastener is a nail, whereby the installation action is driving the nail, through the central bore, whereby the force of the installation action is impact force, having a primary force component normal to the underlying surface.

5. The sealing fastening member of claim 1, in which the protruding portion is annular.

6. The sealing fastening member of claim 1, in which the protruding portion is non-annular.

7. The sealing fastening member of claim 1, further comprising a groove in the bottom contact surface located radially outward of the protruding portion, whereby the partially liquified protruding portion may at least partly flow into the groove as the bottom contact surface comes into contact with the underlying surface, whereby the bottom contact surface may seat securely on the underlying surface.

8. The sealing fastening member of claim 1, in which the main body is shaped as the frustum of a cone.

9. The sealing fastening member of claim 1, in which the sealing fastening member is made of at least one material chosen from the group of natural rubber and synthetic rubber.

10. The sealing fastening member of claim 9, in which the synthetic rubber is chosen to include at least one of the group butyl rubber, polybutadiene rubber, styrene-butadiene rubber, halogenated polyisobutylene rubber, and ethylene propylene diene monomer (EPDM).

11. The sealing fastening member of claim 1, in which the underlying surface is an underlayment located on roof sheathing.

12. A sealing fastening member comprising:
a main body that has
a central bore for receiving a fastener;
a bottom contact surface;
a protruding portion protruding from the bottom contact surface;
whereby,
during an initial liquification phase:
the fastener extends through the central bore and at least partially into an underlying surface;
the protruding portion is in contact with the underlying surface, the bottom contact surface thereby being at a distance from the underlying surface;
the protruding portion is caused to at least partially liquify under the force of an installation action carried out on the fastener and, in an at least partially liquified state, to seal around a point of penetration of the underlying surface by the fastener;
during a second phase:
the bottom contact surface is in contact with the underlying surface; and
the fastener is secured in the underlying surface;
in which:
the main body also forms a spacer between a first item and a second item;
the fastener is a threaded screw, whereby the installation action is screwing the screw through the central bore, whereby the force of the installation action has a primary component of rotational frictional between the protruding portion and the underlying surface; and
the protruding portion is annular;
the sealing fastening member is made of at least one material chosen from the group of natural rubber and synthetic rubber;
said main body further including a groove in the bottom contact surface located radially outward of the protruding portion, whereby the partially liquified protruding portion may at least partly flow into the groove as the bottom contact surface comes into contact with the underlying surface, whereby the bottom contact surface may seat securely on the underlying surface.
